(19) United States
(12) Patent Application Publication
(10) Pub. No.: US 2015/0247790 A1
(43) Pub. Date: Sep. 3, 2015

(54) Microfluidic Assisted Cell Screening

(71) Applicant: PRESIDENT AND FELLOWS OF HARVARD COLLEGE, Cambridge, MA (US)

(72) Inventors: Burak Okumus, Cambridge, MA (US); Dann Huh, Brighton, MA (US); Dirk Landgraf, Boston, MA (US); Johan Paulsson, Cambridge, MA (US)

(21) Appl. No.: 14/427,256

(22) PCT Filed: Sep. 16, 2013
(86) PCT No.: PCT/US2013/059971

§ 371 Date: Mar. 10, 2015

Related U.S. Application Data
(60) Provisional application No. 61/701,266, filed on Sep. 14, 2012.

(51) Int. Cl. G01N 15/14; B01L 3/00

(52) U.S. Cl. CPC G01N 15/1463; B01L 3/502738; B01L 3/502761; B01L 3/502746; B01L 3/502715; G01N 15/1484; G01N 15/1436; B01L 2300/0654; B01L 2300/0877; B01L 2300/123; B01L 2300/14; B01L 2200/0647; B01L 2300/0636

(57) ABSTRACT

A microfluidic system includes a microfluidic channel. The microfluidic channel includes a control layer substantially enclosed within a soft polymer, a cell covering element, and a flow channel between the cell-covering element and control layer enclosed within the soft polymer. The control layer is operable to move towards and exert a pressure on the cell-covering element. Related apparatus, systems, techniques, and articles are also described.

### RELATED APPLICATIONS

This application claims priority to U.S. Provisional Patent Application No. 61/701,266, filed Sep. 14, 2012, the contents of which are hereby incorporated by reference.

### TECHNICAL FIELD

The subject matter described herein relates to imaging of microbial cells.

### BACKGROUND

Flow cytometry (FC) is a laser based, biophysical technology employed in cell counting, sorting, biomarker detection and protein engineering. FC generally includes suspending cells in a stream of fluid and passing them by an electronic detection apparatus. It allows simultaneous multi-parametric analysis of the physical and/or chemical characteristics particles. FC can be used in the diagnosis of health disorders, such as blood cancer, and has many additional applications in basic research, clinical practice, and clinical trials.

Microscopy is the use of microscopes to view samples and objects that cannot be seen with the unaided eye. Microscopy can include optical, electron, and scanning probe. Optical and electron microscopy involve the diffraction, reflection, or refraction of electromagnetic radiation/electron beams interacting with the specimen, and the subsequent collection of this scattered radiation or another signal in order to create an image. This process may be carried out by wide-field irradiation of the sample (for example standard light microscopy and transmission electron microscopy) or by scanning of a fine beam over the sample (for example confocal laser scanning microscopy and scanning electron microscopy). Scanning probe microscopy involves the interaction of a scanning probe with the surface of the object of interest.

FC and microscopy are the two major methods-of-choice for the screening of cells. Microscopy can provide high data quality. FC can provide high throughput, that is, an immense amount of data in short time scales. However, in combining the two techniques, there is a tradeoff between throughput and data quality.

Microscopy can require careful sample preparation and handling (which can sometimes be disruptive to the native biology and quite laborious), as well as virtually constant attention by an operator during experimentation. On the other hand, FC: (1) offers (i) poor sensitivity for low protein expression levels in general and (ii) highly inaccurate cell-size information for microbial cells; (2) is expensive; and (3) requires demanding maintenance. Finally, (4) microbial cells are usually not used in the FC facilities due to the fear of contamination.

Cell-based screening is used in biological research and drug discovery, trying to identify substances (e.g. small molecules, peptides, RNAi) that induce a particular phenotypic change within a cell. Typically such phenotypic changes are monitored through the use of fluorescent indicators and/or changes in cell morphology.

To enable substances to be screened in a high throughput manner, current screening technologies rely on one either automated digital fluorescent microscopy and/or flow cytometry. Both of these methods have their pros and cons: Microscopy is highly sensitive—allowing detection of single fluorescent molecules—and provides superior information in terms of cell morphology and size, as well as protein localization and abundance. In contrast, flow cytometry enables much higher throughput screening, with analysis and sorting of >500,000 cells per minute. An ideal screening technology would therefore combine the best features of both these methods.

### SUMMARY

In one aspect, a microfluidic system includes a microfluidic channel. The microfluidic channel includes a control layer substantially enclosed within a soft polymer, a cell covering element (e.g., coverslip), and a flow channel between the cell covering element (e.g., coverslip) and control layer enclosed within the soft polymer. The control layer is operable to move towards and exert a pressure on the cell-covering element (e.g., coverslip).

In another aspect, a system includes a soft polymer layer, a plurality of parallel control layers substantially enclosed within the soft polymer layer, a cell covering element, and a plurality of flow channels between the cell covering element and the plurality of control layers. Each control layer is operable to move towards and exert a pressure on the cell covering element.

In another aspect, a method includes applying a pressure to a soft polymer located on substantially one or more sides of a flow channel thereby causing the soft polymer to close the flow channel and seal against a cell-covering element (e.g., coverslip). The flow channel contains a flow comprising a plurality of samples suspended in a fluid applied to the flow channel under a pressure. The flow pressure is increased such that the seal is broken slightly, allowing samples to slip between the soft polymer and the cell-covering element (e.g., coverslip).

The above aspects can include one or more of the following features. The soft polymer can include polydimethylsiloxane (PDMS). The control layer can be a valve. The control layer can be a dead end channel running in a perpendicular direction to the flow channel. When no pressure is applied to the control layer, the flow channel can be open such that a plurality of samples can flow freely in the flowchamber traversing an imaging camera field rapidly. When the control layer is operated to exert pressure, the soft polymer can deflect to seal against the cell-covering element (e.g., coverslip). When the control layer is operated to exert pressure, a flow of a plurality of samples suspended in fluid can cause the samples to slip between the polymer layer and cell-covering element (e.g., coverslip). The flow can be reduced (e.g., stopped, paused, or curtailed) such that the polymer layer collapses against the cell covering element (e.g., coverslip) immobilizing one or more samples. The immobilized samples can be imaged. A camera can be arranged such that a portion of an intersection of the flow channel and the control channel resides within the field of view of the camera.

The samples can be cells. The system can be used for cell screening.

The flow pressure can be reduced such that samples are immobilized between the soft polymer and the cell covering element (e.g., coverslip). The cells can include prokaryotic cells, e.g., bacterial cells such as E. coli, Clostridium perfringens, Lactobracillus brevis, and the like. Alternatively, cells can include encaryotic cells, e.g., mammalian cells, protist, amoeba, and the like. The pressure can be applied to the soft polymer by a control layer.

The subject matter described herein provides many advantages. The current subject matter achieves both high sample throughput and high data quality. The current subject matter can look at non-adherent cells (as they are growing if desired) with the full capabilities of microscopy, e.g. single-molecule detection, (potentially) superresolution, and brief time-lapse movies. The current subject matter is versatile, easy-to-maintain, and cost-effective since it is compact, can sit on any inverted microscopy system, and relies on inexpensive, disposable microfluidic chips. Fully automated, hands-off integration with a growth chamber in an environmental chamber not only can provide physiologically relevant measurements but also enables running more specialized cell growth assays (e.g. turbidostat and chemostat).

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1A-C are a series of cross-section views of an example microfluidic platform configured for cell screening and imaging;

FIG. 2 is a three dimensional illustration of the flow channel, the control channel, and the camera;

FIG. 3 is a series of cross section views of the example microfluidic platform illustrated in FIG. 1A-C;

FIG. 4A-C illustrate a series of cross-section views of the example microfluidic platform of FIG. 1A-C;

FIG. 5 is a picture illustrating the exterior of an example implementation of a microfluidic platform configured for cell screening and imaging;

FIG. 6 is a picture illustrating the exterior of another example implementation of a microfluidic platform configured for cell screening and imaging;

FIG. 7A-B are two bright-field microscopy photographs taken using the above-described subject matter;

FIG. 8 is a process flow diagram for a method in accordance with the current subject matter;

FIG. 9A-C are three photographs of various assays acquired using Microfluidics Assisted Cell Screening (MACS);

FIG. 10 illustrates a system in which a growth chamber can be included upstream of the imaging device;

FIG. 11 is a schematic illustrating an example system for using MACS for cell sorting;

FIG. 12 illustrates a polymer layer with pockets, trenches, or compartments formed therein;

FIG. 13A-C is a series of photographs illustrating varying durations (indicated in the gray boxes on the bottom-right of each image) of the half-open valve state;

FIG. 14A-B includes a schematic of a connections employing three-way and check valves, and peristaltic pumps according to the example;

FIG. 15 is a photograph illustrating the detection of primary conjugation via MACS;

FIG. 16 is a plot illustrating a sample turbidostat curve;

FIG. 17 is a two-step workflow chart for recovery of one single-cell-of-interest amongst one million others;

FIG. 18 is a photograph of a MACS7×7 chip;

FIG. 19 shows plots A-D illustrating an example implementation of MACS and results of monitoring cell density;

FIG. 20 is a schematics of MACS in combination with the growth chamber shown in FIG. 19;

FIG. 21 illustrates plots A-D operating MACS to detect rare phenotypes;

FIG. 22 is a table illustrating different preparations of PDMS compositions;

FIG. 23 are plots A-C illustrating imaging of E. coli cells; and

FIG. 24 is two plots illustrating images acquire by MACS to evaluate cell wall mutants in E. coli.

Like reference symbols in the various drawings indicate like elements.

### DETAILED DESCRIPTION

When cells pass through a microfluidic channel, their motion can be stopped or impeded for a period of time to allow for imaging (e.g., with a camera and microscope), after which the cells can be released. The stopping or impeding of motion reduces effects of motion blur in the acquired images. The stopping or impeding can be accomplished by, for example, selectively exerting a force on a portion of the microfluidic channel (e.g., a “pinch point”), using a soft polymer to momentarily trap the cells for imaging. Additionally or alternatively, the stopping or impeding can be accomplished by, for example, exerting a force on the microfluidic channel using a soft polymer to create a seal and then increasing the flow pressure such that the seal is broken slightly, allowing cells to slip between the soft polymer and the channel. Soft, as used herein, can be to express that the polymer or material can have some level of flexibility and can deflect under pressure applied by a microfluidic pump. Reduction of the flow pressure can then trap the cells for imaging.

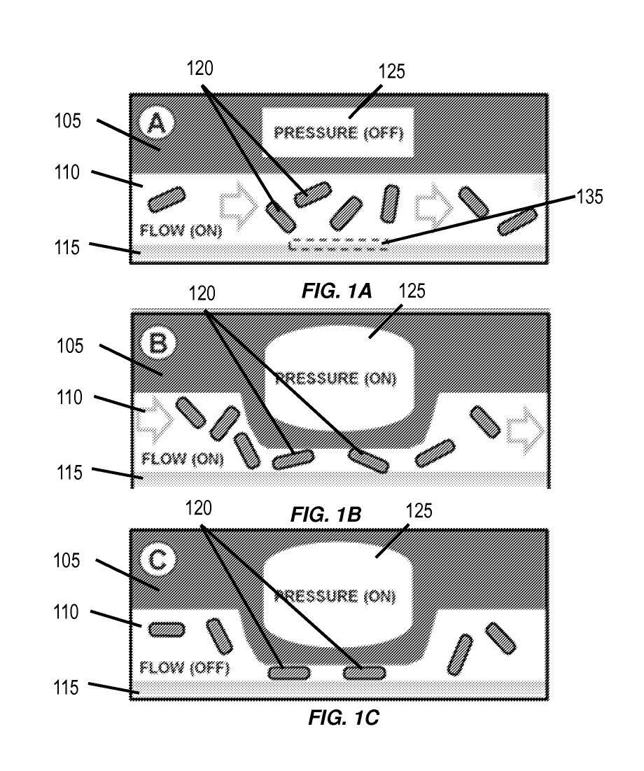

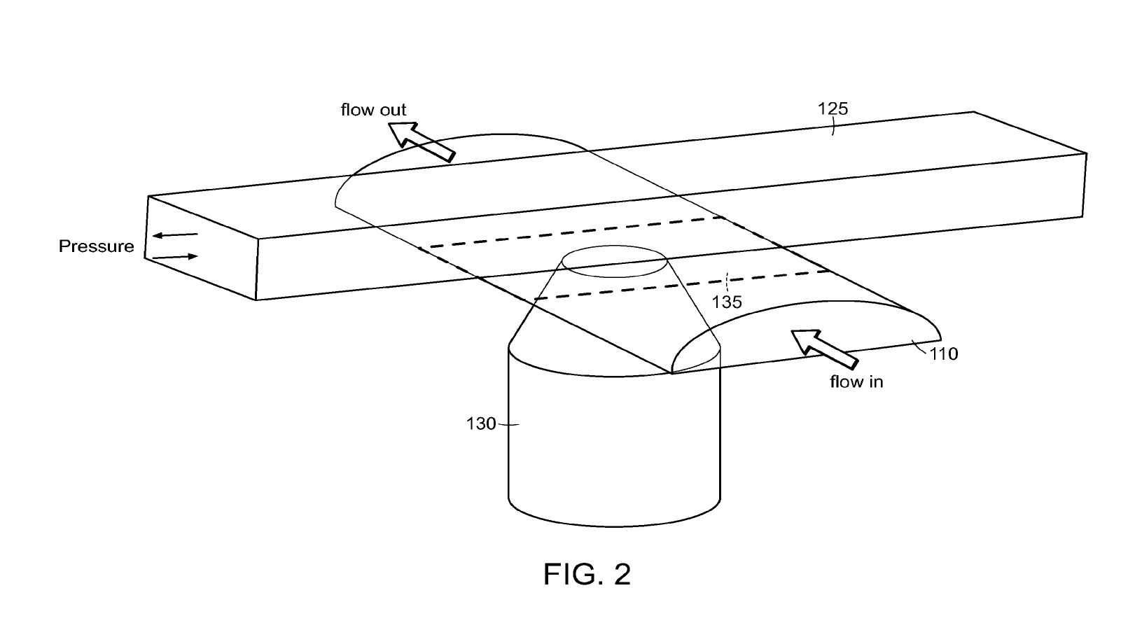

FIG. 1A-C are a series of cross-section views of an example microfluidic platform configured for cell screening and imaging. The micro fluidic platform includes a flow channel 110, which is bordered on one side by a cell covering element 115 and on an opposing side a polymer layer 105. The cell covering element 115 can include, for example, a cover slip, and the polymer layer 105 can include, for example, a soft polymer such as PDMS. PDMS belongs to a group of polymeric organosilicon compounds that are commonly referred to as silicones. It is also called dimethicone. The shear modulus of the soft polymer, e.g., PDMS, can vary with preparation conditions, but can be less than 30 GPa, and in some implementations between 100 kPa to 3 MPa. The microfluidic platform further includes a control layer 125 within or on top of the polymer layer 105 that is capable of selectively exerting a force (e.g., expanding) towards the cell covering element 115. The control layer 125 can include, for example, a dead-end channel formed from the polymer layer 105 that is running in a perpendicular direction to the flow channel 110. Since, in the example, the polymer layer 105 can be formed of a soft and flexible polymer (e.g., PDMS), the control layer 125 can be actuated by injection of water or other fluid into the control layer 125. The injected fluid causes an increase in pressure, which causes the flexible polymer to expand (e.g., stretch or deform). Cells 120 such as bacteria suspended in a fluid can travel through the flow channel 110. A camera 130 or other imaging means (e.g., as shown in FIG. 2) can be located such that cells traversing the flow channel 110 are within the camera field of view when they are trapped by the control layer 125. The position in the flow channel 110 for trapping and imaging the cells is referred to as the ₚinch point 135 or the camera field of view. The camera 130 can include a microscope or other lens and a light source (e.g., darkfield, brightfield, laser, strobe, and the like) for focusing and illuminating the cells 120 in the pinch point 135.

FIG. 2 is a three dimensional illustration of the flow channel 110, the control channel 125 and the camera 130. The polymer layer 105 and cell covering element 115 is not illustrated in FIG. 2, although it should be understood that the control channel 125 is formed from the polymer layer 105 and the cell covering element 115 resides between the flow channel 110 and the camera 130.

Referring again to FIG. 1A-C, in the example shown in FIG. 1A, no pressure is applied to the control layer 125. The flow channel 110 is open such that the cells 120 flow freely in the flow channel 110 traversing the imaging camera field (in FIG. 1A-C, the flow is from left to right). In the example shown in FIG. 1B, the control layer 125 is pressurized by injection of water. The polymer layer 105 (e.g., thin PDMS membrane) can deflect to seal against the cell covering element 115 (e.g., coverslip) due to the flexibility of the polymer. Flow rate or the pressure applied to the flow channel 110 can then be adjusted to a level that would be able to overcome the pressure where a seal at the pinch point 135 is broken slightly. When this occurs the cells 120 can start slipping between the polymer layer 105 and the cell covering element 115. In the example of FIG. 1C, illustrating a closed state, flow can be stopped or reduced. The polymer layer 105 (e.g., PDMS) collapses against the cell covering element 115 (e.g., coverslip) in a closed state and immobilizes the cells 120 for subsequent imaging. New cells 120 from solution can be introduced/trapped/imaged by repeating the cycle illustrated in FIG. 1A-B-C. In some examples, simply collapsing the PDMS membrane against the cells, (i.e., going directly from FIG. 1A to FIG. 1C and skipping FIG. 1B), can lead to displacement of the liquid and the cells 120 altogether resulting in no cell trapping.

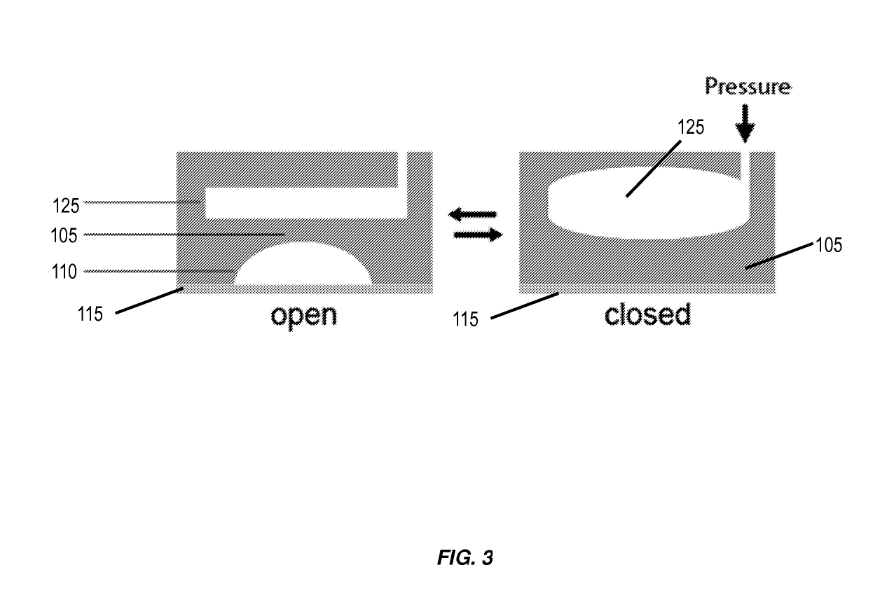

FIG. 3 is a series of cross section views of the example microfluidic platform illustrated in FIG. 1A-C. The cross section views are at an angle perpendicular to the view illustrated in FIG. 1A-C (e.g., the flow of the flow channel 110 is into (or out of) the figure). In the example illustrated in FIG. 3, the flow channel 110 has a domed or curved cross section. When pressure is applied to the control channel 125, the pinch point 135 can be considered in a closed state. Thus, the microfluidic platform can operate similar to a valve, in which the flow of the solution in the flow channel 110 is controlled.

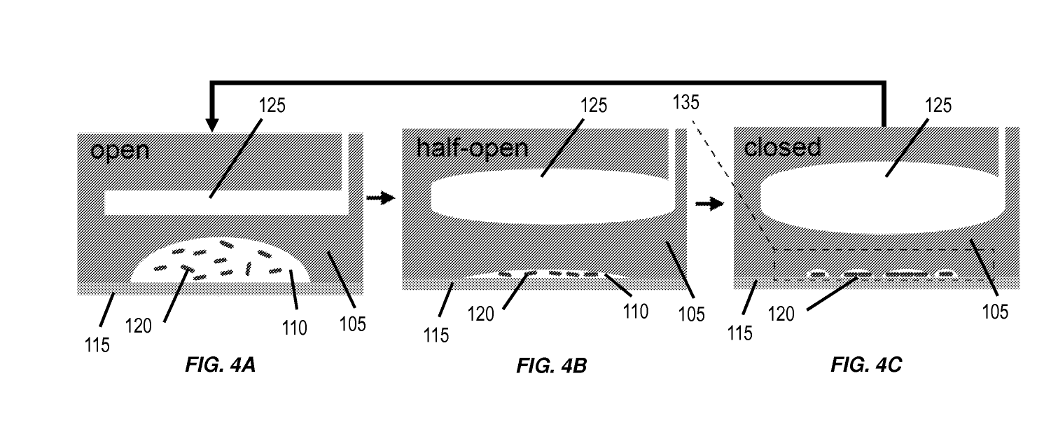

FIG. 4A-C illustrate a series of cross-section views of the example microfluidic platform of FIG. 1A-C. The cross section views are at an angle perpendicular to the view illustrated in FIG. 1A-C. As described with respect to FIG. 1A-C, at FIG. 4A the flow channel 110 is open such that the cells 120 flow freely in the flow channel 110 traversing the imaging camera field. In FIG. 4B, the control layer 125 is pressurized by injection of water. The polymer layer 105 (e.g., thin PDMS membrane) can deflect to seal against the cell covering element 115 due to the flexibility of the polymer. Flow rate or the pressure applied to the flow channel 110 can then be adjusted to a level that would be able to overcome the pressure where a seal at the pinch point 135 is broken slightly. When this occurs the cells 120 can start slipping between the polymer layer 105 and the cell covering element 115. In FIG. 4C, flow can be stopped or reduced. The polymer layer 105 collapses against the cell covering element 115 (the platform is in a closed state) and immobilizes the cells 120 for subsequent imaging. New cells 120 from solution can be introduced/trapped/imaged by repeating the cycle illustrated in FIG. 4A-B-C.

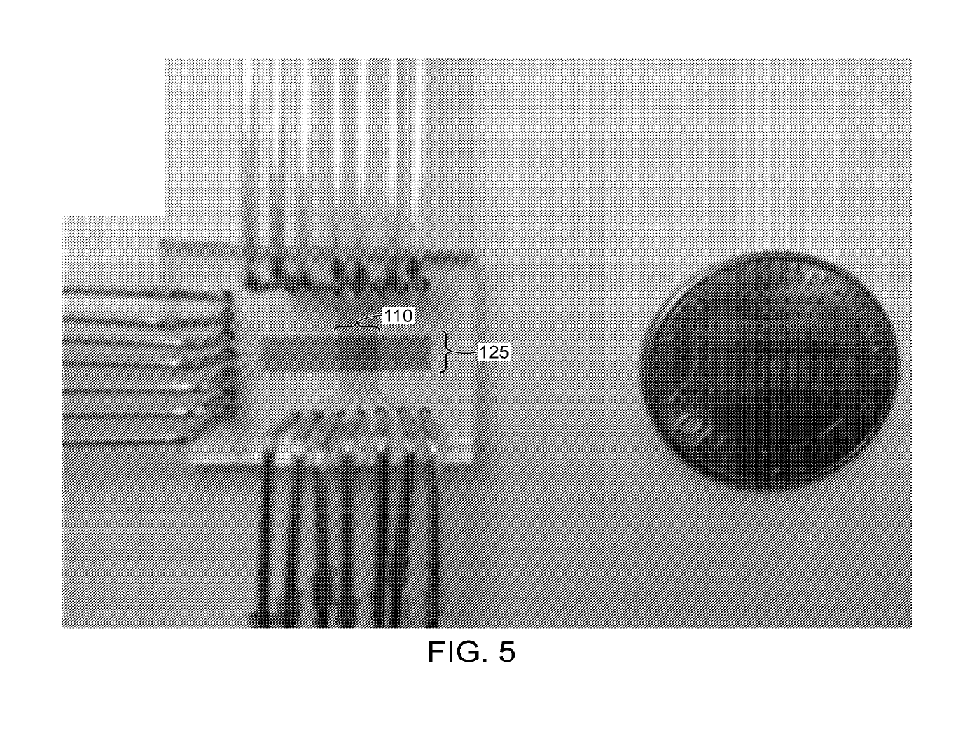

FIG. 5 is a picture illustrating the exterior of an example implementation of a microfluidic platform configured for cell screening and imaging. The platform includes multiple parallel flow channels 110, which are perpendicular to multiple parallel control channels 125. The dead-end channel nature of the control channels 125 is visible. Each control channel 125 can be controlled independently (e.g., with microfluidic pumps). Similarly, the flow of each flow channel 110 can be controlled independently (e.g., with microfluidic pumps). The seven control channels 125 and seven flow channels 110 define 49 intersections or pinch points that can be used independently. In the example implementation, both flow channels 110 and control channels 125 are 200 μm wide. Due to the small footprint of the valve it is possible to scale this up even further up-to hundreds of intersections for the uninterrupted screening of 96-well plates.

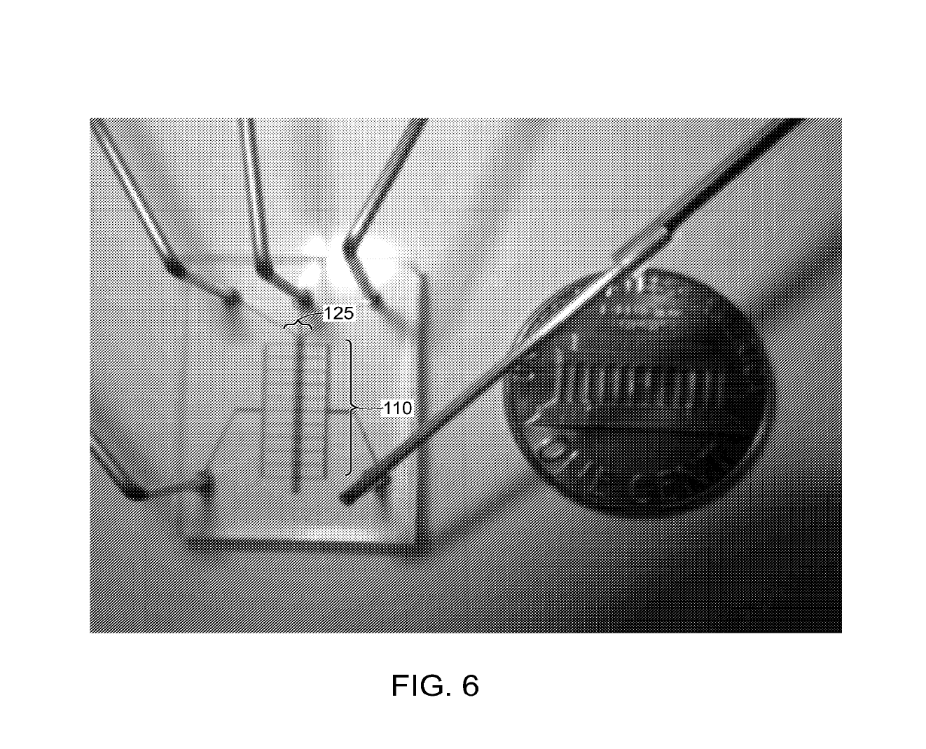

FIG. 6 is a picture illustrating the exterior of another example implementation of a microfluidic platform configured for cell screening and imaging. Three parallel control channels 125 are perpendicular to eleven flow channels 110. The three control channels 125 can be controlled independently. The eleven flow channels 110 in this example are not independently controlled.

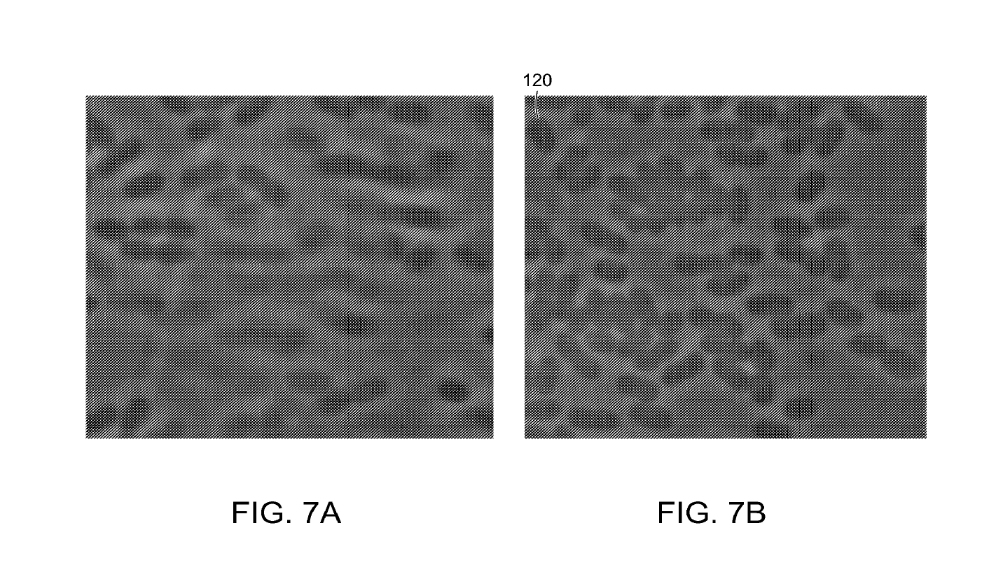

FIG. 7A-B are two bright-field microscopy photographs taken using the above-described subject matter. FIG. 7A is bright-field microscopy photograph of cells 120 that are in motion (e.g., sliding) between the polymer layer 105 and the cell covering element 115 (e.g., as illustrated in FIG. 1B and FIG. 4B, when the platform is in a half-open state). Since the cells 120 are in motion, the cells 120 appear blurred. FIG. 7B is a bright-field microscopy photograph of cells 120 that are immobilized (e.g., as illustrated in FIG. 1C and FIG. 4C, when the platform is in a closed state). Since the cells 120 are immobilized, the cells 120 appear clearly in the photograph.

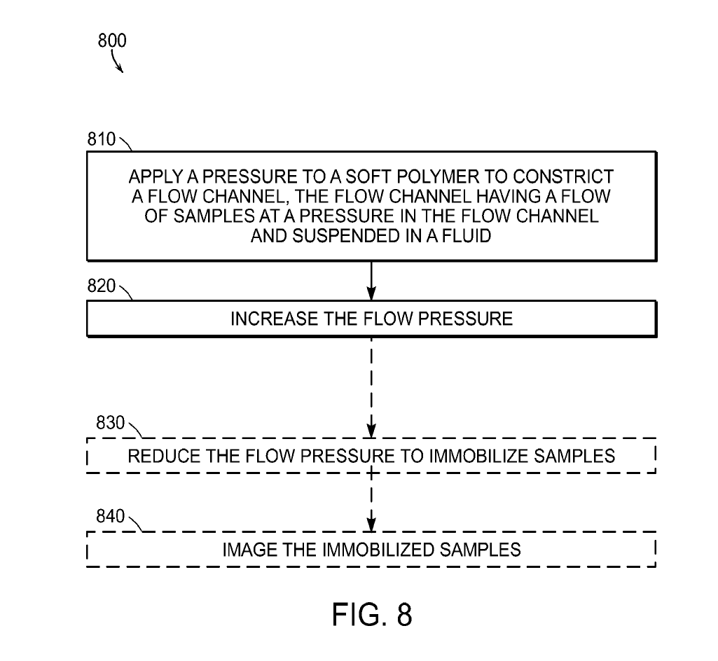

FIG. 8 is a process flow diagram 800 for a method in accordance with the current subject matter. At 810, a pressure is applied to a polymer layer 105 to constrict a flow channel 110. The polymer layer 105 can form a seal with a cell covering element 115. The flow channel 110 has a flow of samples or cells 120 suspended in fluid. The flow can be applied to the flow channel 110 at a pressure (e.g., applied by a pump). At 820, the flow pressure can be increased such that the seal is broken, allowing samples or cells 120 to slip between the polymer layer 105 and the cell covering element 115. Optionally, at 830, the flow pressure can be reduced (e.g., stopped, paused, or curtailed) such that some of the samples or cells 120 are immobilized between the polymer layer 105 and cell covering element 115. Optionally at 830, the immobilized samples or cells 120 can be imaged by, for example, a camera with microscope.

The current subject matter is not limited to imaging cells, but can also include molecules and cell components.

By way of illustration, the following provides an example implementation and manners of use of the above-described subject matter. A microfluidic platform based on a soft-polymer (polydimethylsiloxane—PDMS) for the rapid immobilization-imaging-release of microbial cells that enables high-throughput screening on a microscope (referred to herein as ‘MACS’ for Microfluidics Assisted Cell Screening) is presented. Related apparatus, systems, techniques and articles are also described.

The microfluidic platform enables high throughput microscopy-based screening. MACS utilizes a soft flexible polymer to trap cells flowing through a flow channel 110, once trapped; the cells are imaged and then released. By repeating this process over and over again, MACS enables an increase in the number cells that can be imaged each minute and provides for detecting rare events and mutations. The imaging capability has been tested on both prokaryotes and eukaryotic cells (eukaryotes have typically 100 times larger cell volume than the prokaryotes). MACS enables localization of single molecules in cells. MACS can also be used for analysis of cell growth rates, and can detect weak fluorescent signals.

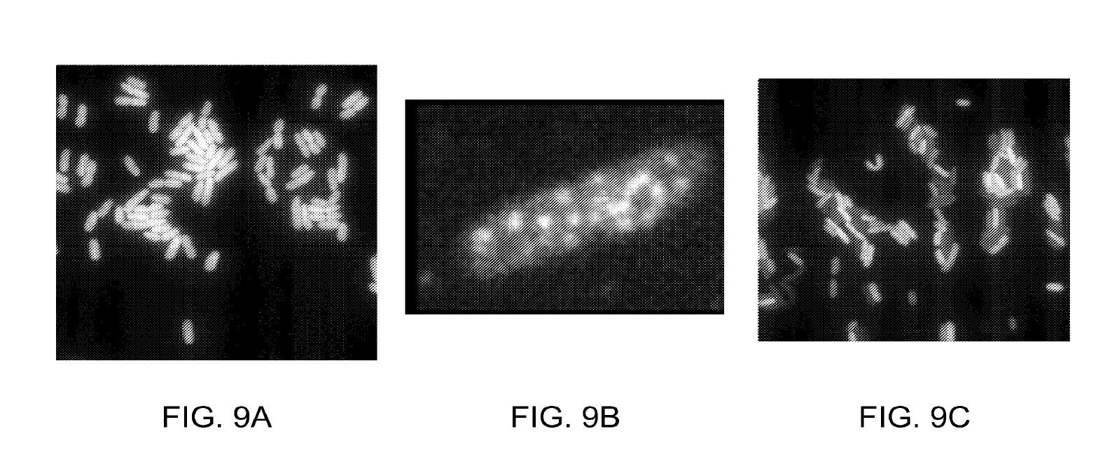

MACS can include a three-state valve configuration (as illustrated in, e.g., FIG. 1A: open, FIG. 1B: half-open, and FIG. 1C: closed), which enables automated, high-throughput microscopy capitalizes on the push-down valve design. (Monolithic microfabricated valves and pumps by multilayer soft lithography. Unger M A, Chou H P, Thorsen T, Scherer A, Quake S R. Science. 2000 Apr. 7; 288(5463):113-6.) In one implementation, a screening throughput rate of 4,000 cells/minute and greater is possible. Additionally, the screening can be performed by microscopy, hence information on precise cell morphology, cell size and accurate fluorescence intensity is readily attainable (e.g., FIG. 9A). It is also possible to obtain spatial localization of intercellular structures. The current subject matter can detect fluorescence to single-molecule detection. By controlling the PDMS stiffness and the applied pressure, molecules can be forced to diffuse more slowly in cell cytoplasm. When (cytoplasmic) molecules of interest exist in very low numbers per cell, they can be directly visualized, and their abundances can accurately be quantified by direct counting (FIG. 9B).

At the single-molecule imaging regime (when the entities under investigation are in very low abundance per cell), by employing different mechanical properties (of different trapping pressures and material stiffness etc.), the current subject matter can enable slowing-down of cytoplasmic diffusion/complete immobilization (referred to as ‘mechanical fixation’ relating to the chemical fixation) of molecules in bacterial cells that can provide unprecedented information on protein abundances as well as in-situ stoichiometries of macromolecular complexes.

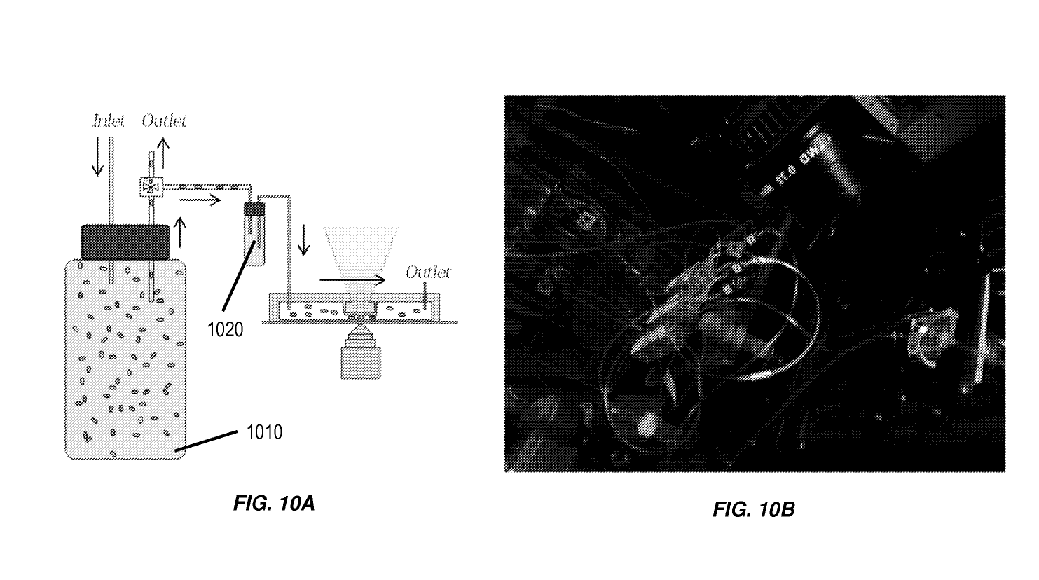

FIG. 10 illustrates a system in which upstream of the imaging device (e.g., camera 130), a growth chamber can be included where cell growth as a function of cell density can be monitored, chemicals/drugs can be added on demand, and at a certain point of the growth curve, desired amount of cells can be injected into the chip for imaging. Each step can be automated. MACS can offer an enabling technology for population genetics or evolution assays and the current subject matter can be implemented, for example, for use in investigating competition between two strains under different antibiotic pressures, studying conjugation of plasmids as a model for spreading disease, detecting rare mutants with certain morphologies, monitoring cellular physiology as a function of cell density in the context of entry into stationary phase or diauxic shift etc.

In the current subject matter, the cells can stay in solution until the time of imaging as opposed to common assays (i.e. agar pad, poly-lysine) that require cell immobilization on surfaces, which are shown to be prone to altering the cell physiology especially under prolonged observation.

Fully automated imaging of microbial cultures during continuous growth at various optical densities, as well as the implementation of chemostat and turbidostat modes, are possible, for example, when using a growth chamber. Elements can be kept in a temperature-controlled incubator (which can be fully automated), enabling cells to be imaged with limited or no perturbation to their native physiology.

Therefore, using the current subject matter it is possible to look at rare events (for instance a certain phenotype which appears in one cell per thousands), build statistics for protein abundances at the level of single-cells, and do ratiometric analysis (FIG. 9C) between various phenotypes (e.g., for the determination of the relative occurrences between distinctly labeled strains to monitor their competition or co-evolution/adaptation) without minimal interruption. It is also possible to perturb or manipulate a subsample of cells (e.g. Isopropyl β-D-1-thiogalactopyranoside (IPTG) induction, small chemical or drug treatment) prior to imaging. Additionally, the current subject matter can include incorporation of a sorting capability, akin to a fluorescence activated cell sorter. Embodiments of the current subject matter can resemble fluorescence-activated cell sorting (FACS) in terms of throughput while retaining the sensitivity of microscopy—down to the level of single-molecule detection.

FIG. 9A-C are three photographs of various assays acquired using MACS. FIG. 3A depicts illustrates quantifying the expression level of a fluorescent protein reporter at the single-cell level in a high-throughput manner. It has been shown that 50 f snapshots per minute (˜4000 cells/min) can be acquired in an automated fashion. FIG. 9B depicts MACS fluorescence sensitivity down to single-molecule detection. Bright spots are cytoplasmic single RecB-GFP molecules made clearly visible during 30 msec exposure time due to squishing-induced slowing down. FIG. 9C depicts that ratiometric imaging between strains can reveal the interplay between individual phenotypes within a population over time. In this particular example, the spread of a conjugative plasmid within a liquid culture over time (donor cells, recipient cells, and transconjugant cells) is studied.

FIG. 10A depicts an integration of an upstream growth chamber 1010 as well as an intermediate chamber 1020, which enables automation and enables a multitude of assays. FIG. 10B is a photograph of an example of the device of FIG. 10A. In this example, all components are enclosed in a temperature-controlled incubator.

The system can be used with, for example, E. coli, fission yeast, mammalian cells, and budding yeast. It is possible to use other cell types. As a new platform for cell-based, high throughput screening (HTS), the platform can be used, for example, in the pharmaceutical and biotechnology industries for the identification of lead drugs, perform toxicity tests, screen for Antibiotics effects, and carry out functional genomics screens.

The current subject matter can be used for quantifying mRNA numbers in live microbial cells in a high-throughput fashion with a MS2 tagging system (Real-time kinetics of gene activity in individual bacteria. Golding I, Paulsson J, Zawilski S M, Cox E C. Cell. 2005 Dec. 16; 123(6):1025-36.). The current subject matter can be used to implement an automated 96-well plate screening. In combination with a robot arm and the essential external connections, MACS can enable automated 96-well plate screening. It is possible to rapidly screen libraries of, for instance, directed evolution (e.g. for the development of brighter fluorescent proteins), fluorescent protein fusions (e.g. for seeing effect of small molecules on cell morphology or protein abundance/localization), and mutants (e.g. looking at the library of cell wall mutants to decipher morphological changes with respect to mutation, or seeing the effects of cell wall targeting antibiotics, changes in the susceptibility of the cell wall can be monitored at different squishing pressures).

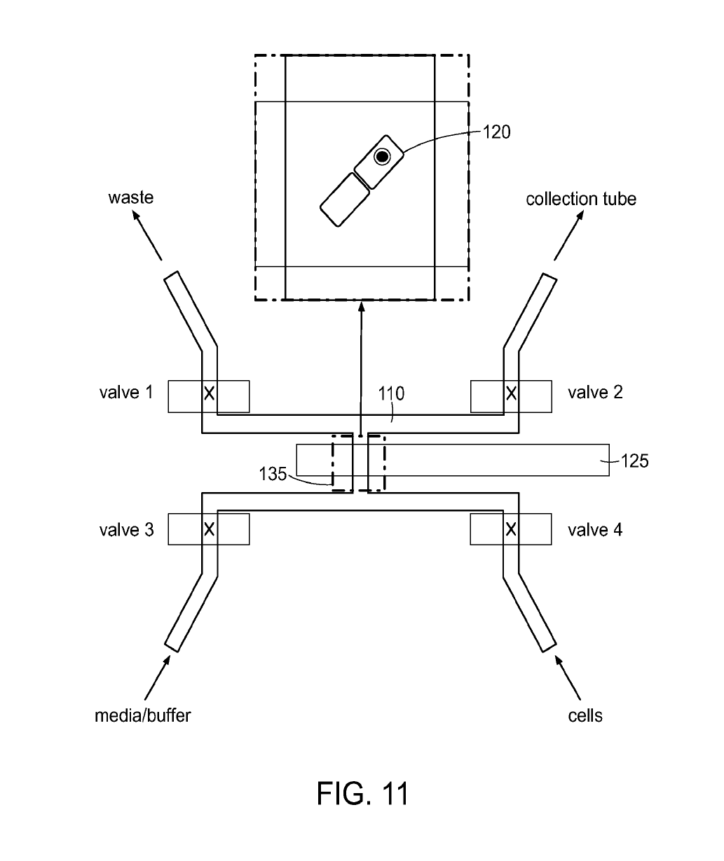

The current subject matter can enable cell sorting. For example, cell sorting can occur based on expression levels of fluorescent reporters or morphology/localization (FIG. 11). MACS enables sorting based on a multitude of criterion (e.g. cell size, state along the cell cycle) that can accurately be assessed.

FIG. 11 is a schematic illustrating an example system for using MACS for cell sorting. Flow channel 110 and control channels 125 are shown illustrated. Cells 120 can be introduced in sufficient dilution such that they are monitored one at a time at the trapping region (e.g., pinch point 135) and by default are sent to waste (when valves 1 and 4 are open). When a cell 120 of interest (shown here is a dividing cell with some localized signal in one of the siblings) is captured, valves 2 and 3 are opened and the trapped cell is diverted into a collection tube.

Larger valves can be fabricated so that the total area where the cells are immobilized will be larger thus increasing the screening throughput. Significantly more cells can be captured at a time, which can then be imaged by moving the automated stage laterally in small incremental steps. (The field of view on the imaging camera is typically smaller than the cell capturing area.). This enables improved cell imaging throughput.

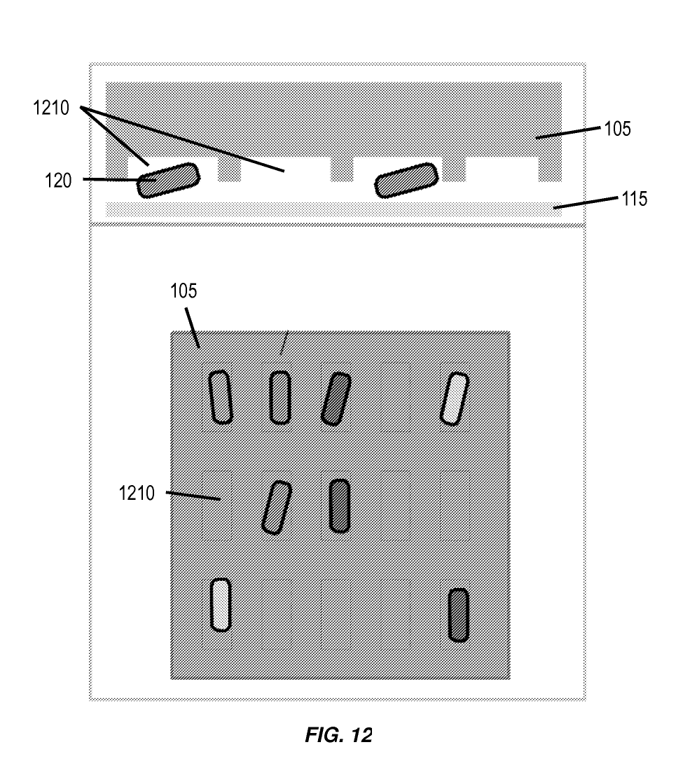

If there are two adjacent cells while imaging, one dim and the other bright in fluorescence, the dim cell can appear to be brighter than it actually is, because of the light coming from its bright neighbor. This can complicate the quantitative measurement, and to avoid this problem the spacing between cells can be larger. FIG. 12 illustrates a polymer layer 105 with pockets, trenches, or compartments 1210 formed therein. Cells can tend to align themselves along compartments 1210 that can be formed on the PDMS surface during fabrication. At the top of FIG. 12 is a side-view. Cells are preferentially getting trapped within the pockets 1210 fabricated into PDMS. Trapping in the pockets 1210 can occur during the half-open state. At the bottom of FIG. 12 is a top-view. Due to larger spacing between cells, measured intensity of dim cells may not be affected by bright cells. Pockets with sizes that are similar to cell dimensions can be fabricated, for example in an array or matrix configuration, cells can be arranged in a regular pattern with well-defined separations. Thus, cells can be aligned in a well-defined array by patterning the PDMS surface.

Cell density can be adjusted for minimizing cross talk between neighboring cells. As depicted in FIG. 12, random positioning of cells during immobilization may pose a problem for the faithful determination of expression levels. This can be addressed by varying the duration for the half-open state (e.g., as illustrated at FIG. 1B and FIG. 4B) of the valve during cycles of imaging causing cells to be spread across the surface with various densities.

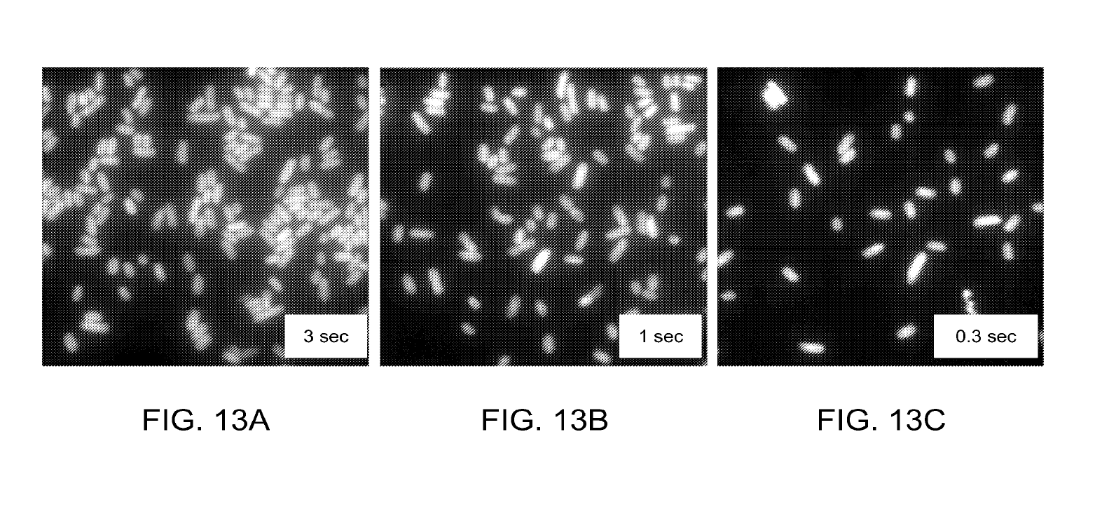

FIG. 13A-C is a series of photographs illustrating varying durations (indicated in the gray boxes on the bottom-right of each image) of the half-open valve state. FIG. 13A illustrates a photograph taken with a three second half open valve state. FIG. 13B illustrates a photograph taken with a one second half open valve state. FIG. 13C illustrates a photograph taken with a 0.3 second half open valve state. When the bleed through of the measured signal between neighboring cells does not substantially interfere with image quality, a longer period of half open valve state can be used to increase throughput. Using a shorter period of half open valve state, e.g., 0.3 sec, can result in better separation between cells. The cells may still end up close to each other, but those relatively rare cases can be discarded during image analysis without compromising the statistics significantly.

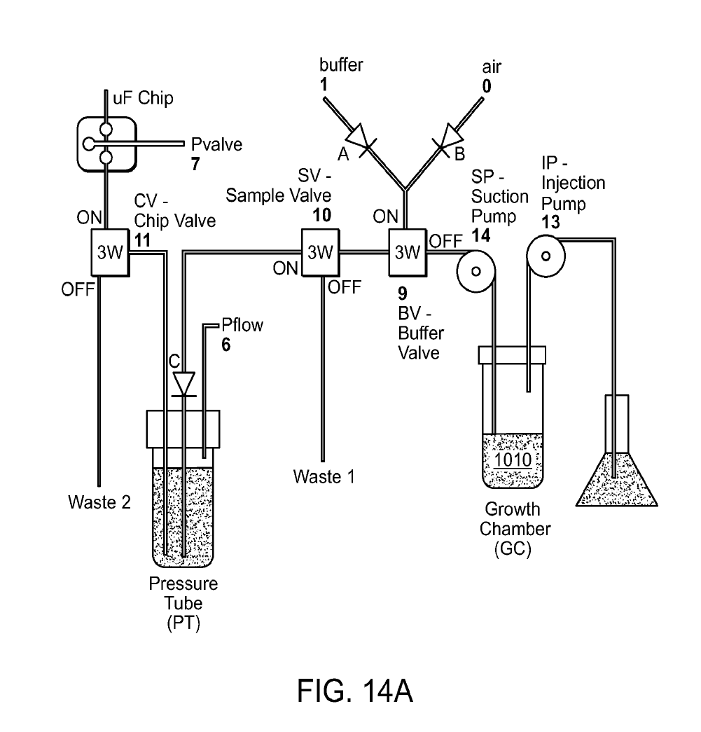

In another example, FIG. 14A is a schematic of a connections employing three-way and check valves, and peristaltic pumps according to the example. The cell density inside the growth chamber 1010 can be measured via nephalometry. Except for peristaltic pumps, all fluidic flow in the system can be pressure driven. MACS can be attached to an upstream growth chamber within a temperature controlled incubator to enable capture of dynamic progression of a cell population via microscopy with unprecedented temporal and spatial resolution as well as minimal user intervention. A growth chamber 1010 can be placed upstream of MACS so that microscopy on cells can be performed on demand while monitoring the cell density in real-time (as suggested above with respect to FIG. 10A and 10B). The time from the growth chamber to imaging (“the door-to-door commute”) can be 3 minutes. The entire system can reside in a temperature-controlled incubator, each step can be automated, and the cells can remain in solution until the very moment of imaging. An intermediate chamber 1020 (e.g., pressure tube 1410 in FIG. 14A) makes it possible to treat cells with chemicals (e.g. drugs or inducers) prior to imaging, leaving the rest of the population in the growth chamber undisrupted. MACS can be free of potential disruptions such as temperature shock, long delay between cell harvesting and imaging, and the like. Cells can be accurately harvested at a specific desired optical density, enabling day-to-day reproducibility for measurements.

FIG. 14B illustrates bacteria (MG1655 background) growing in the growth chamber 1010 in M9 minimal media with 0.2% glucose. Bold arrow marks the inoculation of the media with cells. Cell-size and number of replication forks per cell progress were monitored along the bacterial growth curve. The samples were taken from the growth chamber at various optical densities, and cells were imaged almost instantaneously. Samples from the culture can be taken at different times (indicated by circles) first into the pressure tube, then into the MACS chip for imaging. The topleft inset displays a representative snapshot from 4th timepoint. The cell size and number of replication forks (bright spots in cells) can be determined and the bottomright inset shows the cell length distribution obtained from ˜5000 cells (distribution for number of replication forks is not shown). Therefore, the automated MACS can provide a dynamic picture of a growth curve with information at the single-cell level.

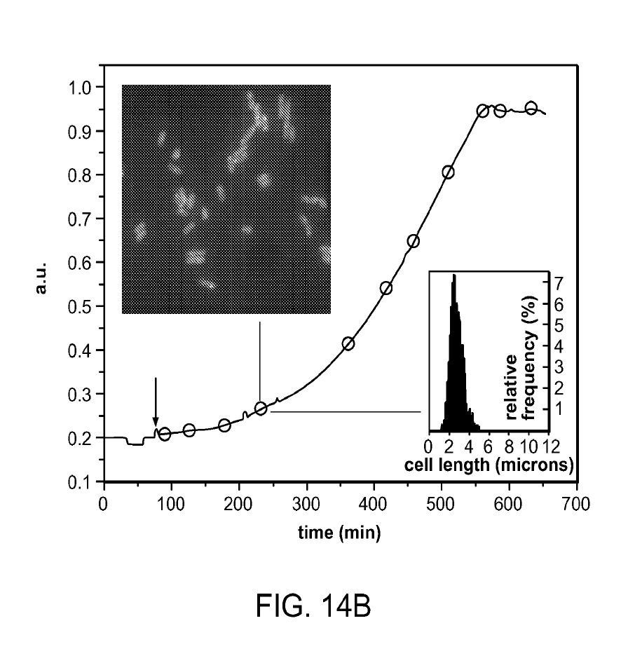

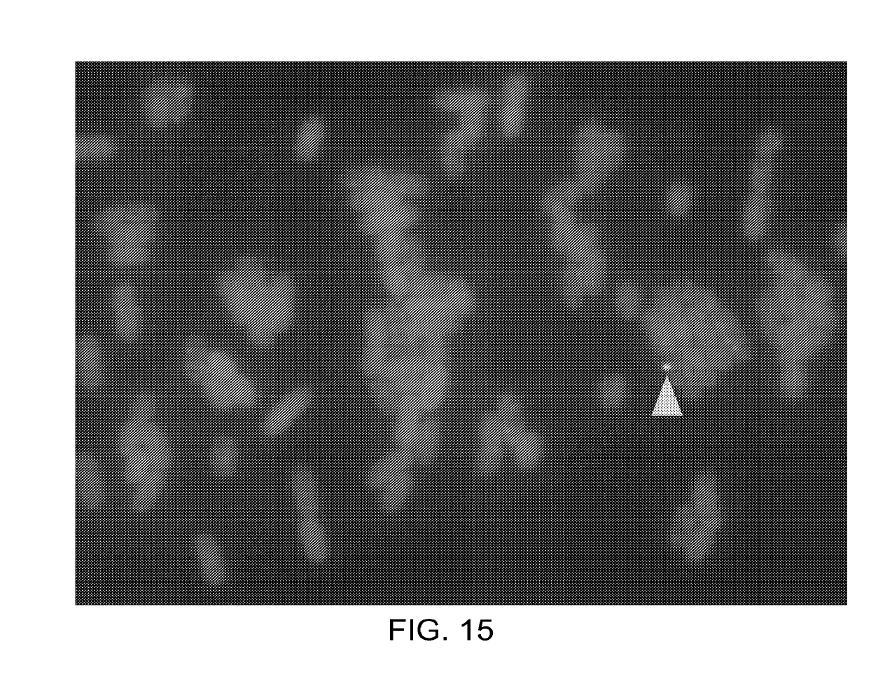

Another aspect of the growth chamber is that one can operate it in the chemostat or turbidostat mode that enables multitude of assays. In one of such assays, the spread of a plasmid over time via conjugation (total transfer FIG. 9C, primary transfer FIG. 15) within a mix of donor and recipient cells grown at the turbidostatic regime (FIG. 16) of the growth chamber was looked at. Thus, MACS can be operational for the monitoring of population dynamics.

Using the subject matter described herein, it is also possible to keep cells growing in a very early exponential phase where a steady-state growth of bacteria occurs and constantly monitor cells within this period. Out of convenience, this is usually what is assumed for many experiments, but in reality is impossible to achieve with the conventional assays since this steady-state growth period is very transient and the cell concentrations are small. The turbidostat mode in combination with almost instantaneous imaging via MACS can make this a reality. It is also possible to introduce disruptions in the growth chamber (e.g., drug, temperature, pH) repetitively, and watch cells as they adapt to those perturbations. It is also possible to collect significant statistics for very transient events (such as entry or exit from stationary phase) by repetitively allowing them happen on the turbidostat and instantaneous imaging on MACS.

FIG. 15 is a photograph illustrating the detection of primary conjugation via MACS. Donor and recipients cells are illustrated. The localized focus (marked by a gray arrowhead) represents a primary conjugation event.

FIG. 16 is a plot illustrating a sample turbidostat curve. The inoculation of cells in media is indicated at 1610. Cells are kept to grow at the exponential growth phase (between two optical densities of 0.4 and 0.55). Region 1620 resembles the period of (exponential) growth whereas the region 1630 marks the period of dilution (using growth media).

The current subject matter can be used for the detection of extremely rare events (down to one in a million) in a population of cells. To that end, instead of repetitive stopping of cells to take snapshots, one aspect of the current subject matter can include keeping cells flowing through the pinch point 135 in the half-open valve state (e.g., as illustrated in FIG. 1B and FIG. 4B) as a single layer and acquisition of images can occur at a predetermined rate (for example, a video rate of 30 frames per second). The presence of the rare event of interest can be monitored (e.g., in one application the rare events of interest can be marked by a high expression of a fluorescent marker or a localized signal). Therefore, the screening throughput can be increased. When the sought-after event is detected in the camera field of view (such detection can be automated through the use of machine vision techniques), the flow canoe stopped such that the cell-of-interest is immobilized and detailed images (e.g. in different fluorescent channels) can be acquired.

It has been shown that using the current subject matter, primary transconjugants can be photographed, which were proposed to exist in a mixed population of donor and recipient cells with a frequency of one-in-a-million (hence “the Loch-Ness monster” of bacterial conjugation). Note that this is different from what is shown on FIG. 15, since the version of the plasmid in the experiment depicted on FIG. 15 is a mutant with an elevated conjugation frequency.

As a further example, red-fluorescent protein (RFP) expressing strains (kanamycin resistant) in the midst of cyan-fluorescent protein (CFP) expressing strains (ampicillin resistant) with high dilution were spiked and the number of events was counted for a certain volume going through the imaging field of view using a predetermined image record rate. To be able to detect every event of interest, a magnification can be used for imaging such that the field of view on a CCD camera included all of the valve area. The same volume of cells plated on an LB plate (with kanamycin) resulted in a colony number, which is in very good agreement with what was detected via the current subject matter used with a predetermined image record rate. This suggests that almost all events of interest that goes through the interrogated volume can be detected.

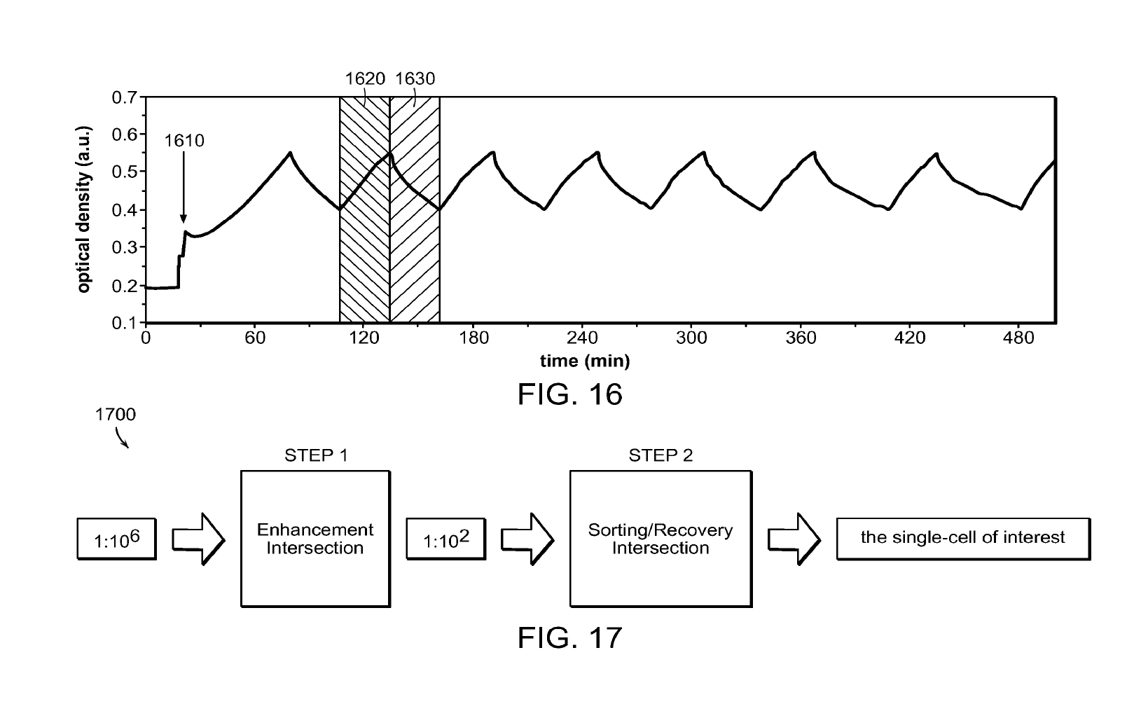

FIG. 17 is a two-step workflow chart 1700 for recovery of one single-cell-of-interest amongst one million others. First step of the process enables 10,000 times of enhancement (the boxes indicate the ratio of the event of interest and the background), and the ˜100 cells from the first step are sent through the sorting/recovery intersection one by one, where the cell of interest can be recovered using the sorting scheme depicted in FIG. 11 for downstream interrogation. Furthermore, a combination of this process and the sorting application shown in FIG. 11 can enable the recovery of very rare cells in a sea of others, which can provide novel insights with the current single-cell sequencing capabilities. The rare event of interest can be captured in a first MACS intersection by previously described imagining means, and then divert the captured volume into a second downstream MACS intersection where cells are sent through one by one such that the specific cell-of-interest can be recovered for the downstream analysis (e.g. sequencing).

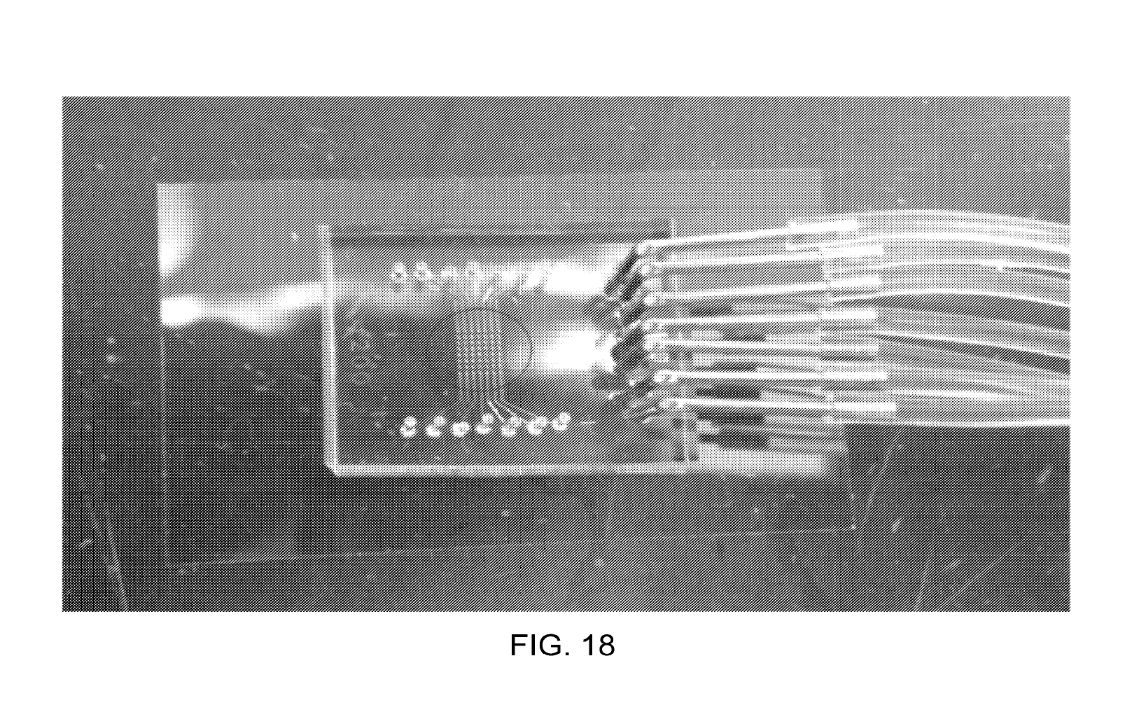

In one example, to account for the accumulation of debris, a chip was fabricated with an array of individual MACSing intersections or pinch points 135 (so-called MACS7×7 for 7 flow and 7 control lanes with a total of 49 intersections, FIG. 18). FIG. 18 is a photograph of a MACS7×7 chip with control line connections made, and flow line connections left out for clarity. Circled is the region bearing 49 MACSing intersections. Debris accumulation can be a problem during actuation of the control layer 110 (e.g., valve). Debris generally does not get stuck permanently unless pressed against the surface during active use of MACS and otherwise generally debris eventually washes away). Thus, intersections or pinch points 135 that remain passive do not collect debris and a neighboring intersection can be used on demand should the actively used intersection get clogged. For the example chip of FIG. 18, acquiring images of approximately one million cells per intersection is possible (a total of ˜50 million cells per chip). It is possible to scale the implementation of FIG. 18 even further with any number of intersections (for example, hundreds of intersections for an uninterrupted screening of 96-well plates).

MACS can be utilized to assay cells' response to shear flow (compare with BioFlux by Bucher Biotec), which may especially be relevant for red blood cells under various mutations or disruptions.

The following are example High Content Screening (HCS) systems: Staccato, Ensemble and Reprise by Caliper; ImageXpress systems by Molecular devices; BD Biosciences-BD Pathway; and GEs IN Cell Analyzer 2000/6000. These apparatus primarily involve screening of adherent cells on (usually) 96-well plates, and may not be suitable for cells in suspension. They may be merely platforms for doing automated imaging on different samples in a parallel and automated fashion but may not provide higher-throughput than what is offered by regular microscopy. One down-side of such systems is that they employ air objectives—up to 100× magnification—with limited numerical aperture (maximum NA for air objectives is around 0.9) hence provide sub-optimal sensitivity (the problem with using immersion objectives—that could have up to 1.4 NA—with these systems is the practical issue that the immersion medium—i.e. oil or water—would be dispersed during large travel distances across a 96-well plate disrupting the imaging).

The following are example imaging flow cytometers: ICyte Imaging Cytometer by Compucyte, Imagestream-X by Amnis and FlowSight. These systems (as the name implies) may be flow cytometers with imaging capabilities and may be more suited for High Throughput Screening (FITS) for non-adherent cell types. Compared to standard flow cytometers however, throughput may be reduced from ˜10,000 cells/sec to ˜1000 cells/sec at the expense of capturing actual images via a camera. However, the system may produce only low quality images because of (1) the brief residence time of cells within the camera field-of-view and (2) long working-distance air-objectives, which are low magnification, and low NA, up to 40× with NA ˜0.7 (a brief description of Amnis' device can be found at: http://medicine.yale.edu/labmed/cellsorter/instrumentation/amnis.aspx).

Using MACS, cells can flow continuously as a single-layer without stopping (which enables sifting through many more cells within a certain time, hence substantially higher-throughput) until a rare event of interest shows up within the field-of-view and flow may be stopped to capture the cell-of-interest such that detailed images (e.g. in different fluorescent channels) can be acquired. MACS can potentially be utilized to assay cells' response to shear flow (compare with BioFlux by Bucher Biotec) or their resistance upon applied pressures (e.g., for screening the effects of cell-wall targeting drugs). With the proper alterations, MACS can lend itself to microscopy based cell sorting or enrichment.

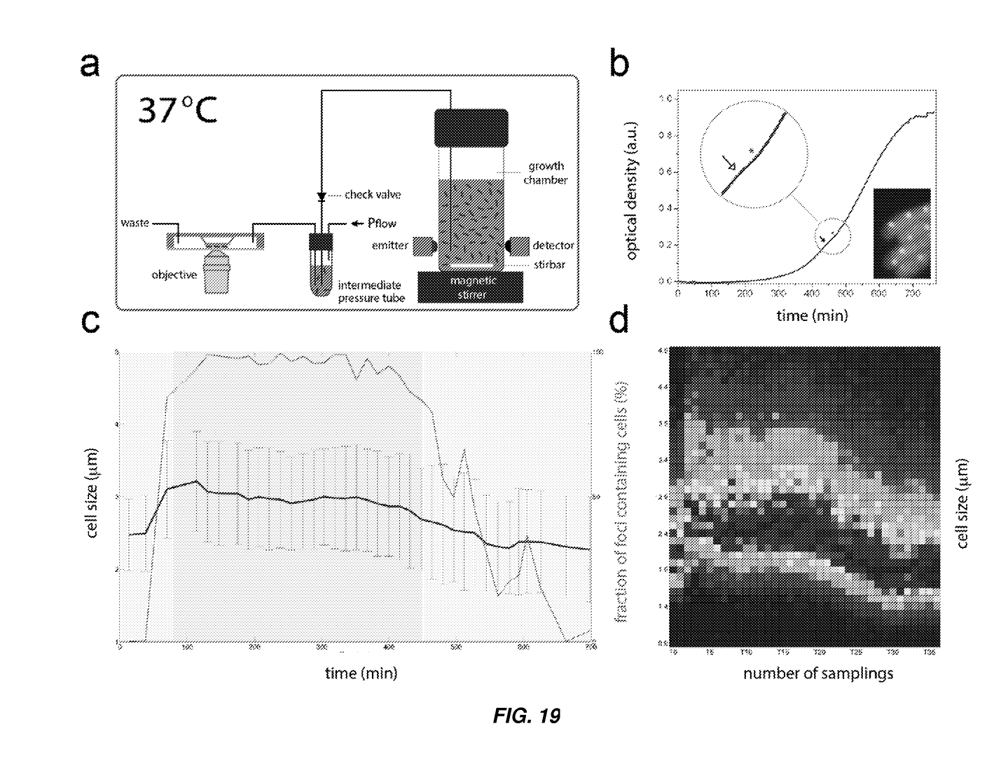

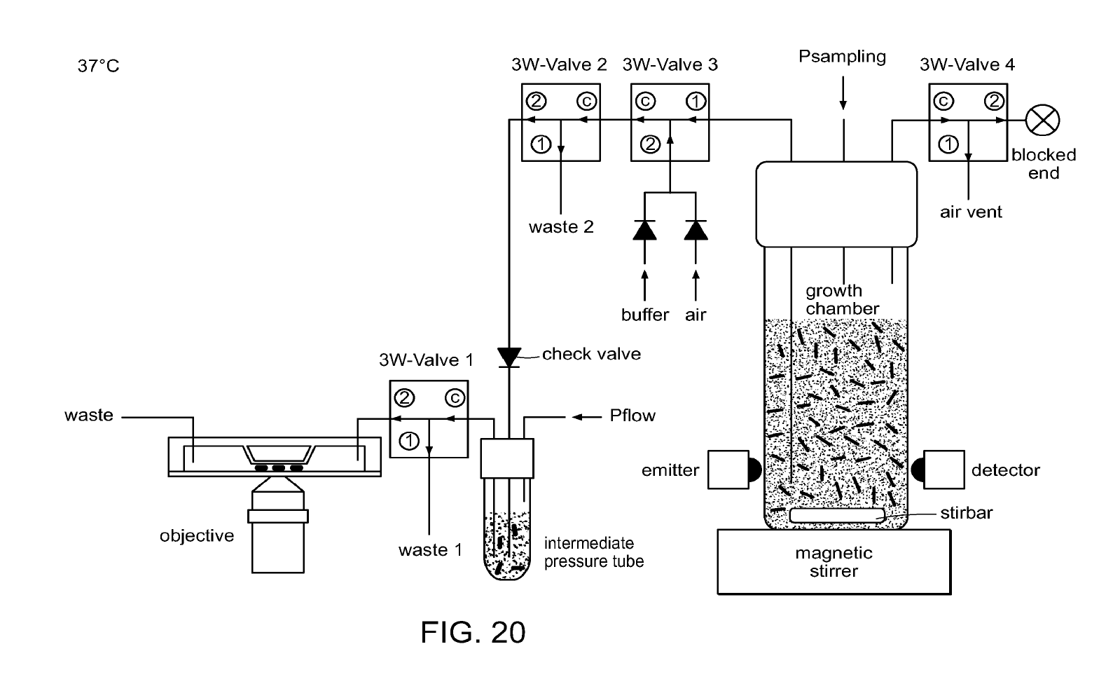

FIG. 19 shows plots A-D illustrating an example implementation of MACS and results of monitoring cell density. At plot A, the cell density inside the growth chamber is monitored in real time, and cells are sent to the intermediate pressure tube on demand (complete schematics is shown in FIG. 20). The check valve prevents backflow into the growth chamber when the intermediate pressure tube is pressurized. The whole system is kept within a temperature incubator set at 37° C. The detector placed at 135° (which is misrepresented as 180° here for simplicity of drawing) with respect to the emitter measures the scattered light, which serves as a metric for OD. At plot B is a bacterial growth curve. Overnight culture was inoculated at t=0 min. The onset of the temporary decline in OD at ˜430 min., and the kink at ˜470 min. is marked by an arrow and an asterisk, respectively. Inset (bottom right) is a representative snapshot along the growth curve, with two fluorescence channels overlaid, showing the cytoplasmic marker and the replication forks. At plot C is mean cell size (black line) with standard deviation and fraction of cells displaying DNA replication activity (grey line) over time. Shaded regions mark distinct growth phases, namely phase 1 (left), phase 2 (middle), and phase 3 (right) respectively. At plot D, cell lengths for each sampling were pooled together to build histograms, which are depicted as a heatmap. The distributions start shifting around the 22^{th} sampling, which corresponds to t˜430 min, (arrow in plot B).

FIG. 20 is a schematics of MACS in combination with the growth chamber shown in FIG. 19. Cell culture in the growth chamber is mixed by means of a magnetic stirrer. Check valves allow unidirectional flow. Buffer flow is also achieved using pressure. Three-way valves (3W-Valve) enable flow selection by either diverting a common inlet (c) to two outlets (1 or 2), or two inlets (1 or 2) into a common outlet (c).

The desired combination of valve states can be selected to carry out a particular task. For instance, passive aeration of the culture is achieved through 3W-Valve4, which is connected to open air through (1) by default. Sampling pressure (P_{sampling}) can be applied and a choice (2) of 3W-Valve4 to be able to pressurize the growth chamber to push cells out. In order to direct the cells then into the pressure tube, the 3W-Valve3 is set to (c), and 3W-Valve2 is set to (2). The sample can be directly sent from the intermediate pressure tube into MACS by setting 3W-Valve1 to (2). To be able to rapidly empty the intermediate pressure tube into waste 1 when preparing it for the next sampling, the 3W-Valve1 can be set to (1). Similarly, the intermediate pressure tube or MACS with buffer can be rinsed with buffer, the tubing blow dried by air, or the growth chamber actively aerated, and the like. With further modifications, it can be possible to implement mixing and aeration in the PT, as well as treatment of the samples with and drugs or inducers without affecting the rest of the growing cell.

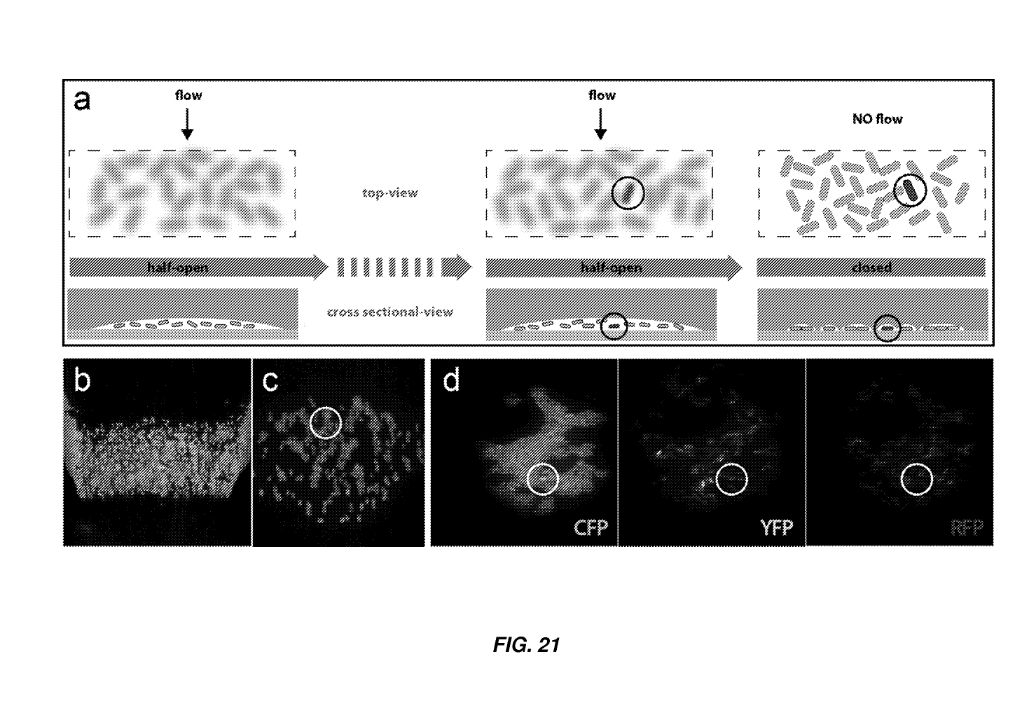

FIG. 21 illustrates plots A-D operating MACS to detect rare phenotypes. At A, running MACS continuously in the half-open state allows for flowing cells as a single layer until the cell of interest (brighter cell, circled) appears within the field of view. Stopping the flow at this point allows for immobilizing that very cell to capture its detailed snapshots. Upper panel, topview: constant cell flow happens within the dashed boundary. Cells appear smeared due to flow, except for the closed state which brings cells to full stop. Lower panel, cross-sectional view: flow direction is away from the page, and the control channel is not shown for simplicity. At B, single frame of a movie of fluorescent E. coli cells flowing during the half-open state. Cells appear blurred due to their constant movement within the 30 msec exposure time. At C, images in GFP and RFP fluorescence channels overlaid showing the sought for RFP expressing cell (circled), captured within an average of ˜20 sec. for the spiking-in experiment with 1:100,000 dilution. At D, a cell overexpressing the CFP was captured (circled) as a potential conjugative donor. Images in YFP and RFP channels serve as additional verification.

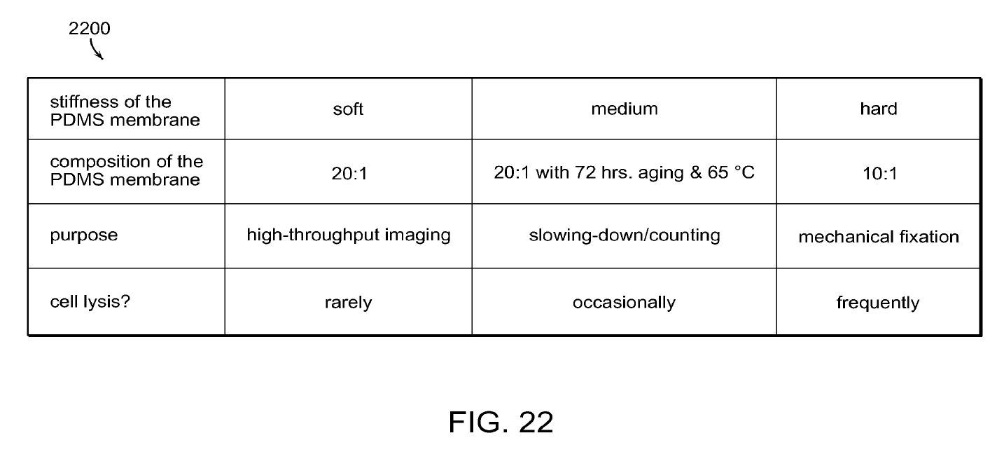

FIG. 22 is a table 2200 illustrating different preparations of PDMS compositions. MACS chips prepared under different PDMS compositions result in different PDMS membrane stiffness that can be used for different purposes.

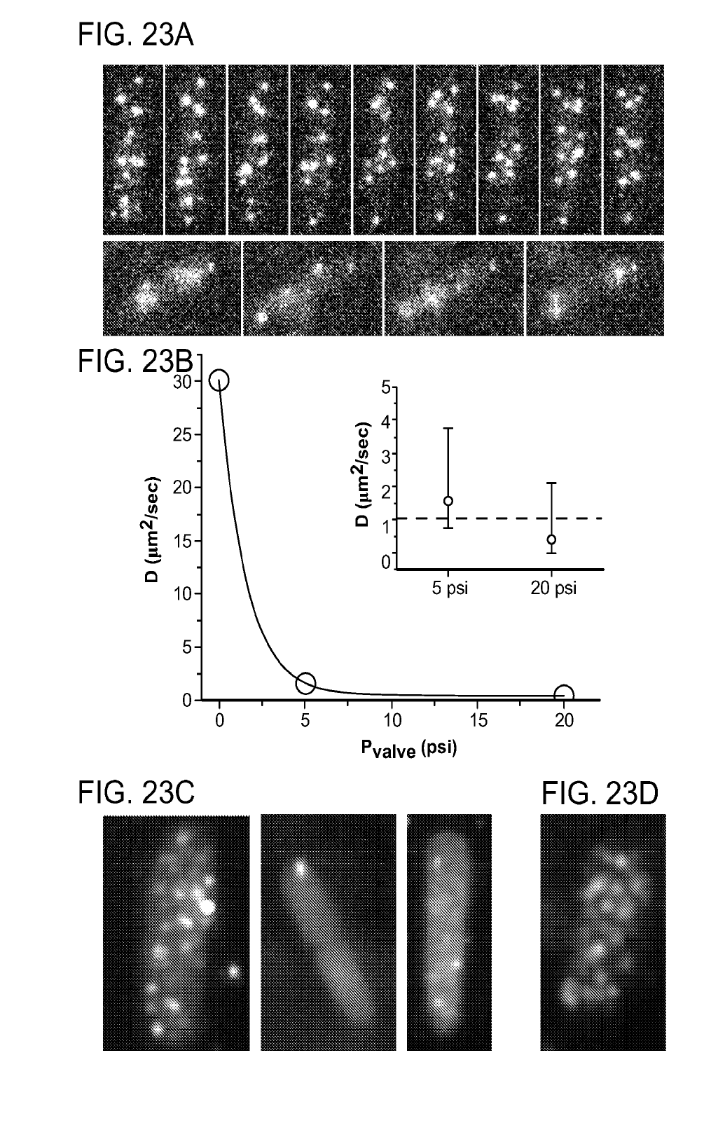

FIG. 23 are plots A-C illustrating imaging of E. coli cells. At A is consecutive frames of for HILO imaging of E. coli cells expressing cytoplasmic mEos2; on MACS (top), and on agar pad (bottom). Exposure time is 30 msec. The fluorescence signal for agar pads appear smeared due to fast diffusion, whereas mEos2 molecules appear as diffraction-limited spots under 3-day aged MACS chips with Pᵥₐₗᵥₑ=20 psi. At B, mean values of D as a function of Pᵥₐₗᵥₑ. The line is shown as a guide to the eye. Inset displays D values obtained for 5 psi and 20 psi (circle: mean; upper and lower lines: max and min values, respectively). Dashed line marks the ‘visibility horizon’ for 30 msec. exposure time; i.e., the D=1 μm²/sec boundary beyond which the molecules traverse a smaller distance than the PSF width to appear as diffraction-limited spots. At C, time lapse movies averaged over 200 frames. Left panel shows a rare case of full fixation that displays discrete spots. In contrast, middle (cell in lower panel of A is shown as rotated 90° counterclockwise) and right (cell shown in the upper panel of A) panels display diffuse signal due to the jittering of molecules. At D, ClpP-HaloTag-TMR strain under the hard (10:1) chip with Pᵥₐₗᵥₑ=20 psi. Time lapse image averaged over several resulting in appearance of discrete spots due to full fixation. Full fixation occurs even for groups of cells that seemed to have resisted against squishing for softer chips.

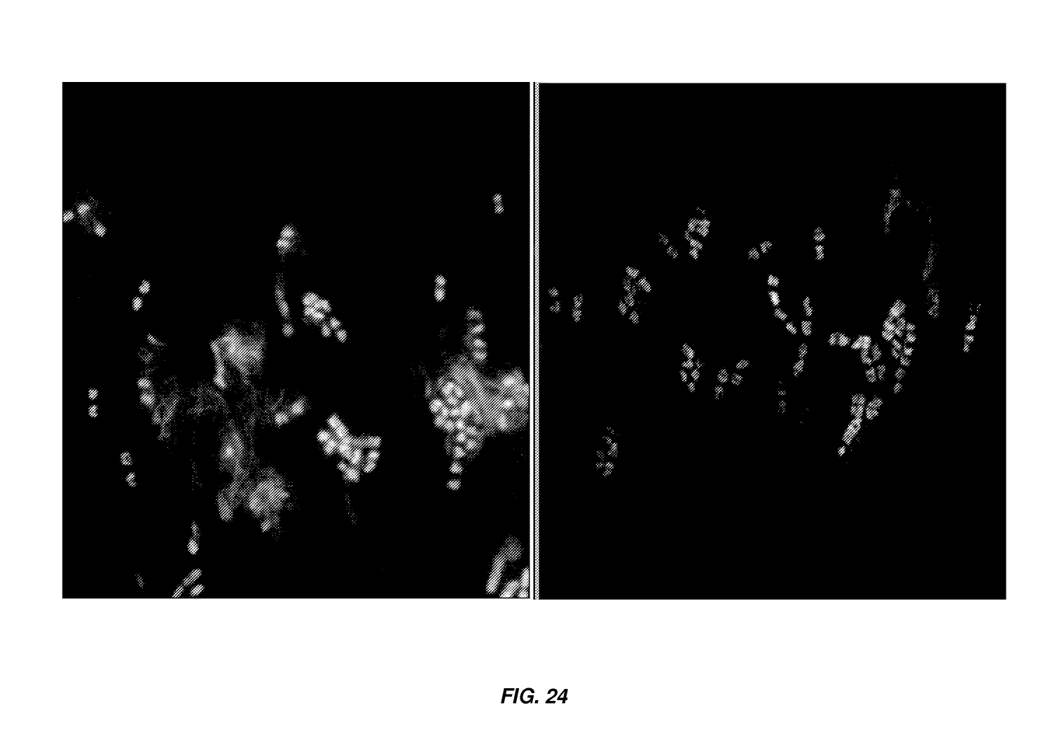

FIG. 24 is two plots illustrating images acquire by MACS to evaluate cell wall mutants in E. coli. Chromosomes are stained with DAPI to visualize cell lysis. Under certain conditions, mutant cells are significantly more amenable to cell lysis indicated by the spread out chromosomes outside the cells, whereas wild type cells remain mostly intact.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A microfluidic system comprising:
a microfluidic channel comprising a control layer substantially enclosed within a soft polymer layer, a cell covering element, and a flow channel between the cell covering element and control layer;
wherein the control layer is operable to move towards and exert a pressure on the cell covering element.

2. The microfluidic system of claim 1, wherein the soft polymer layer comprises polydimethylsiloxane.

3. The microfluidic system of claim 1, wherein the control layer comprises a valve.

4. The microfluidic system of claim 1, wherein the control layer comprises a dead end channel running in a perpendicular direction to the flow channel.

5. The microfluidic system of claim 1, wherein when no pressure is applied to the control layer, the flow channel is open such that a plurality of samples can flow freely in the flow channel traversing an imaging camera field rapidly.

6. The microfluidic system of claim 1, wherein when the control layer is operated to exert pressure, the soft polymer deflects to seal against the cell covering element.

7. The microfluidic system of claim 1, wherein when the control layer is operated to exert pressure, a flow of a plurality of samples suspended in fluid is applied under pressure to cause the samples to slip between the polymer layer and cell covering element.

8. The microfluidic system of claim 7, wherein the pressure is reduced such that the polymer layer collapses against the coverslip immobilizing one or more samples.

9. The microfluidic system of claim 8, wherein the immobilized samples are imaged.

10. The microfluidic system of claim 9, wherein the samples are cells.

11. The microfluidic system of claim 1, wherein the system is used for cell screening.

12. The microfluidic system of claim 1, further comprising a camera arranged such that a portion of an intersection of the flow channel and the control channel resides within the field of view of the camera.

13. A system comprising:
a soft polymer layer;
a plurality of parallel control layers substantially enclosed within the soft polymer layer;
a cell covering element, and
a plurality of flow channels between the cell covering element and the plurality of control layers;
wherein each control layer is operable to move towards and exert a pressure on the cell covering element.

14. The system of claim 13, wherein the soft polymer layer comprises polydimethylsiloxane.

15. A method comprising:
applying a pressure to a soft polymer layer located on substantially one or more sides of a flow channel thereby causing the soft polymer to close the flow channel and seal against a cell covering element, the flow channel containing a plurality of samples suspended in a fluid that is under pressure; and
increasing the flow pressure such that the seal is broken, allowing samples to slip between the soft polymer and the cell covering element.

16. The method of claim 15, further comprising:
reducing the flow pressure such that samples are immobilized between the soft polymer layer and the cell covering element.

17. The method of claim 16, further comprising:
imaging the immobilized samples.

18. The method of claim 15, wherein the soft polymer layer comprises polydimethylsiloxane.

19. The method of claim 15, wherein the samples comprise cells.

20. The method of claim 15, wherein pressure is applied to the soft polymer layer by a control layer.
